(19) United States
(12) Patent Application Publication
(10) Pub. No.: US 2016/0370529 A1
(43) Pub. Date: Dec. 22, 2016

(54) Light Mixing Systems Having Color Free Doublets

(71) Applicant: Fraen Corporation, Reading, MA (US)

(72) Inventors: Marco Angelini, Trivolzio (IT); Robert A. Gobron, Southborough, MA (US)

(21) Appl. No.: 15/185,865

(22) Filed: Jun. 17, 2016

Related U.S. Application Data
(60) Provisional application No. 62/181,157, filed on Jun. 17, 2015.

(51) Int. Cl. F21V 8/00; G02B 27/00; G02B 1/04; F21V 5/00

(52) U.S. Cl. CPC G02B 6/0006; F21V 5/004; F21V 5/002; G02B 27/0025; G02B 1/041; G02B 6/0008; F21V 5/008; F21Y 2115/10; F21Y 2113/10

(57) ABSTRACT

In one aspect, a lighting system is disclosed that includes a light pipe having an input surface for receiving light from at least one light source and an output surface through which light exits the light pipe. A lens doublet comprising two lenses is optically coupled to the output surface of the light pipe for receiving at least a portion of the light exiting the light pipe and projecting the light, e.g., onto a target surface. The lens doublet exhibits a chromatic aberration that is less than the chromatic aberration exhibited by the individual lenses of the doublet. In some embodiments, the lens doublet exhibits a chromatic aberration that is less than about 0.22 diopters for wavelengths over a range of about 450 nm to about 650 nm.

### RELATED APPLICATION

The present invention claims priority to a provisional application entitled “Color Free Doublets” having application No. 62/181,157, filed on Jun. 17, 2015, which is herein incorporated by reference in its entirety.

### BACKGROUND

The present application generally relates to lighting systems, and particularly to lighting systems for mixing light of different colors.

Many lighting applications require mixing of light from multiple light sources producing light of different colors. In many conventional light mixing systems, a lens, or a combination of lenses, is employed for projecting light mixed via a light-mixing rod onto a target surface. The index of refraction of a lens can be different for different colors, thus resulting in the variation of the lens' focal length as a function of incident wavelength. Such dependence of the focal length of the lens on incident wavelength is known as chromatic aberration and can degrade the performance of light mixing systems. For example, chromatic aberration can adversely affect the variation of color temperature over a light spot.

Accordingly, there is a need for improved lighting systems.

### SUMMARY

In one aspect, a lighting system is disclosed that includes a light pipe having an input surface for receiving light from at least one light source and an output surface through which light exits the light pipe. A lens doublet comprising two lenses is optically coupled to the output surface of the light pipe for receiving at least a portion of the light exiting the light pipe and projecting the light, e.g., onto a target surface. The lens doublet exhibits a chromatic aberration that is less than the chromatic aberration exhibited by the individual lenses of the doublet. In some embodiments, the lens doublet exhibits a chromatic aberration that is less than about 0.22 diopters for wavelengths over a range of about 450 nm to about 650 nm.

In some embodiments, the two lenses of the doublet can be formed of different polymeric materials. A variety of materials can be used for forming the lenses of the doublet. Some examples of suitable materials include, without limitation, polymethymethacrylate (PMMA), polycarbonate (PC), polymethacrylmethylimid (PMMI), and silicone. By way of example, one of the lenses can be formed of PMMA and the other formed of PC. Alternatively, one of the lenses can be formed of silicone and the other formed of PC.

In some embodiments, the lens doublet is configured to generate a light spot on its nominal focal plane exhibiting a Color-Over-Angle (COA) variation characterized by CIEX, CIEY less than 0.02 for angles in a range of 0 to about 60 degrees.

In some embodiments, the lens doublet provides a positive optical power in a range of about 10 to about 20 diopters. In many such embodiments, one of the lenses of the doublet can provide a positive optical power (e.g., in a range of about 15 to about 25 diopters) and the other lens can provide a negative optical power (e.g., in a range of about 5 to about 15 diopters).

In some embodiments, at least one surface of at least one of the lenses of the lens doublet can be aspheric, e.g., odd aspherical, extended aspherical, conic, biconic, cubit spline. In some embodiments, the lens doublet can have a diameter in a range of about 25 to about 100 mm.

A variety of light sources can be used. By way of example, the light source can be a multi-color light emitting diode (LED).

The lens doublet can have a variety of different F-numbers, e.g., depending on a particular application. By way of example, in some embodiments, the F-number of the lens doublet can be in a range of about f/0.8 to about f/1.2.

In some embodiments, the lens doublet is movable relative to the output surface of the light pipe so as to adjust the angular spread of the beam projected by the lens doublet.

In some embodiments, the output surface of the light pipe can include surface texturing. In some cases, such surface texturing can be characterized by a plurality of surface undulations having peak-to-trough heights in a range of about 0.01 mm to about 0.25 mm.

In some embodiments, a plurality of microlenses can be coupled to the output surface of the light pipe. Such microlenses can be formed integrally with the light pipe, or can be formed as a separate unit and coupled to the light pipe. In some embodiments, the curved surfaces of the microlenses (i.e., the surfaces through which light exits the microlenses) can be textured. In some cases, such surface texturing can be characterized by a plurality of surface undulations having peak-to-trough heights in a range of about 0.01 mm to about 0.25 mm.

In some embodiments, the light pipe can have a polygonal cross section, e.g., a square, a hexagonal or an octagonal cross section. Further, in some embodiments, the light pipe has a length that is at least 10 times greater than the maximum linear dimension of any of its input and output surfaces. By way of example, for a light pipe having a square cross-section, the length of the light pipe can be at least 10 times greater than the size of the square sides.

In a related aspect, a lighting system is disclosed, which includes a light pipe having an input surface for receiving light from at least one light source (e.g., a multi-color LED) and an output surface through which light exits the light pipe. The lighting system further includes a lens doublet optically coupled to the output surface of the light pipe for receiving at least a portion of the light exiting the light pipe. The lens doublet can include a first lens formed of one polymeric material and a second lens formed of a different polymeric material, where the lenses are configured such that the lens doublet exhibits a chromatic aberration less than about 0.22 diopters over a wavelength range of about 450 nm to about 650 nm.

Further understanding of various aspects of the invention can be obtained by reference to the following detailed description in conjunction with the associated drawings, which are described briefly below (the drawings are not drawn necessarily to scale for ease of illustration).

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A schematically depicts an embodiment of an optical system according to the present teachings,

FIG. 1B is a schematic view of a light pipe employed in the optical system of FIG. 1A for mixing light,

FIG. 2 schematically depicts a multi-color LED that can be used as the light source in the optical system of FIG. 1A,

FIG. 3 schematically depicts a light pipe suitable for use in an optical system according to the present teachings, which exhibits an increasing cross-sectional area from its proximal end to its distal end,

FIG. 4 is a schematic partial view of a light pipe suitable for use in an optical system according to the present teachings, where the output surface of the light pipe includes a plurality of surface textures,

FIG. 5 is a schematic partial view of a light pipe suitable for use in an optical system according to the present teachings having a plurality of microlenses coupled to its output surface,

FIG. 6A is a schematic partial view of a light pipe suitable for use in an optical system according to the present teachings, where the output surface of the light pipe include both surface texturing and a plurality of microlenses,

FIG. 6B is a schematic partial view of a light pipe suitable for use in an optical system according to the present teachings having a plurality of microlenses with textured output surfaces,

FIG. 7 is a partial view of the light pipe of the system depicted in FIG. 1 and a holder in which the light pipe is secured,

FIG. 8A is a schematic view of a lens doublet in which both lenses are formed of PMMA,

FIG. 8B shows calculated focal length shift as a function of incident wavelength for the lens doublet depicted in FIG. 8A,

FIG. 8C shows a calculated RGB spot diagram for the lens doublet depicted in FIG. 8A,

FIG. 9A is a schematic view of a lens doublet in which one lens is formed of PC and another lens is formed of PMMA with an airgap between the lenses,

FIG. 9B shows calculated focal length shift as a function of incident wavelength for the lens doublet depicted in FIG. 9A,

FIG. 9C shows a calculated RGB spot diagram for the lens doublet depicted in FIG. 9A,

FIG. 10A is a schematic view of a lens doublet in which one lens is formed of PC and the other lens is formed of PMMA with lenses cemented together,

FIG. 10B shows calculated focal length shift as a function of incident wavelength for the lens doublet depicted in FIG. 10A,

FIG. 10C shows a calculated RGB spot diagram for the lens doublet depicted in FIG. 10A,

FIG. 11 presents simulated data corresponding to the distribution of red, green and blue light rays on a nominal focal plane of the lens doublet depicted in FIG. 8A,

FIG. 12 presents simulated data corresponding to the distribution of red, blue and green light rays on a nominal focal plane of the lens doublet depicted in FIG. 9A,

FIG. 13 presents simulated data corresponding to the distribution of red, blue and green light rays on a nominal focal plane of the lens doublet depicted in FIG. 10A,

FIG. 14A is a schematic view of a lens doublet in which one lens is formed of PC and the other lens is formed of silicone,

FIG. 14B shows calculated focal length shift as a function of incident wavelength for the lens doublet depicted in FIG. 14A, and

FIG. 14C shows a calculated RGB spot diagram for the lens doublet depicted in FIG. 14A.

### DETAILED DESCRIPTION

The present invention relates generally to optical systems that employ a light mixer, such as a light pipe, for mixing light generated by one or more light sources and at least one projection lens for projecting the mixed light exiting from the light pipe onto a target surface, where the lens is configured to exhibit a low chromatic aberration, e.g., a chromatic aberration characterized by a focal length shift of less than 800 microns for incident wavelengths in a range of about 450 nm to about 650 nm. Various terms are used herein consistent with their ordinary meanings in the art. By way of example, the term “chromatic aberration” is used herein to refer to variation in the focal length of a lens as a function of the wavelength of incident radiation. A lens exhibiting chromatic aberration fails to focus all colors to the same convergence point. The term “about” is used herein to refer to a deviation of at most 5% about a numerical value. The term “lens' is used consistent with its ordinary meaning to refer to an optical element, which typically includes one or two curved surfaces, that converges or diverges light incident thereon. Unless otherwise indicated, the lenses discussed below converge or diverge the incident light via refraction. The term “polymeric material” refers to a material that has a molecular structure consisting mainly, or entirely, of a number of repeating units bonded together. A plastic material is an example of a synthetic polymeric material formed of a wide range of organic polymers, such as polyethylene, polyvinylchloride (PVC), polycarbonate (PC), polymethylmethacrylate (PMMA), that can be molded into shape while soft and then set into rigid or slightly elastic form. The term “achromatic lens doublet” refers to a lens doublet that exhibit a substantially vanishing chromatic aberration at two or more wavelengths in the range of 400 nm to 700 nm. The term “substantially” refers to a deviation of at most 5% relative to a complete state (e.g., a numerical value).

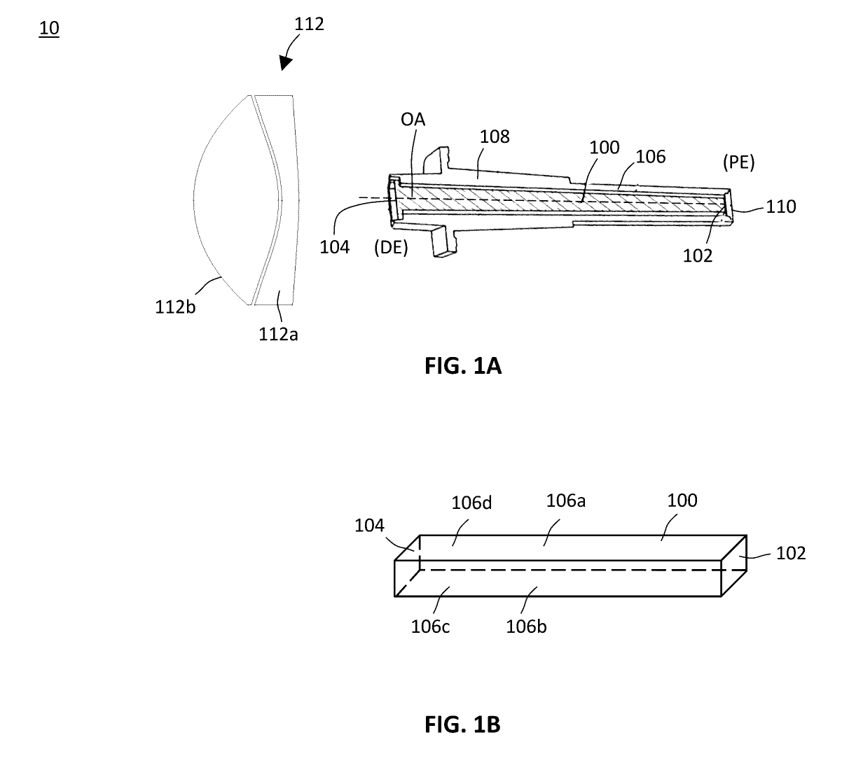

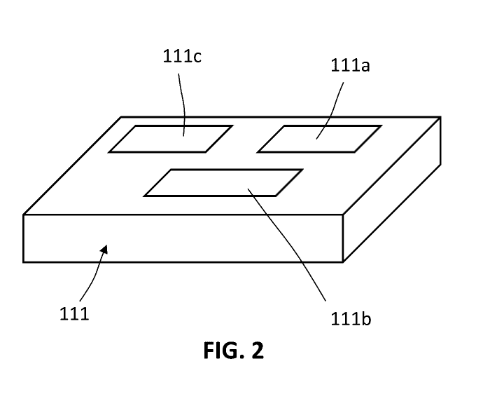

FIG. 1A schematically depicts an optical system (herein also referred to as a light module) 10 according to an embodiment of the present invention, which includes a light pipe 100 extending from a proximal end (PE) to a distal end (DE). The light pipe 100 includes a light input surface 102 at its proximal end, a light output surface 104 at its distal end, and one or more lateral surfaces 106, which extend from the light input surface to the light output surface. In this embodiment, the light pipe 100 is secured within a holder 108.

The light pipe 100 can receive light from one or more light sources 110 via its light input surface 102. Though the input surface 102 is shown as a substantially flat surface in this embodiment, the input surface 102 can have a variety of different shapes and/or surface profiles for efficiently coupling the light received from the light source(s) 110 into the light pipe. For example, the input surface can be shaped so as to avoid or reduce the passage of light through the light pipe 100 without a reflection at the sidewall(s) 106 so as to enhance the mixing of the light rays entering the light pipe and/or to avoid or reduce imaging the light source(s) 110 in the projected light. For example, the input surface can be substantially concave so as to define a cavity for receiving a light source (such as an LED) having a convex light emitting surface.

The light entering the light pipe via its input surface 102 can be transmitted to the light output surface 104 through which the light can exit the light pipe. Some of the light entering the light pipe can be transmitted directly through the light pipe from the input surface 102 to the output surface 104 (i.e., some of the light can propagate from the input surface 102 to the output surface 104 without undergoing reflections at the sidewall(s)), and some of the light can be transmitted from the input surface 102 to the output surface 104 via one or more reflections at the sidewall(s) 106. For example, some light rays incident on the input surface can be refracted at that surface toward the sidewall(s) and undergo one or more reflections at the sidewall(s) before exiting the light pipe through its output surface while some other light rays can strike the input surface at normal or close to normal angles such that they would not undergo a significant change in their propagation direction upon entering the light pipe so as to avoid striking the sidewall(s) as they propagate from the input surface to the output surface.

The sidewall(s) 106 can be adapted to reflect light incident thereon via a wide range of mechanisms. For example, the sidewall(s) 106 can reflect the incident light via total internal reflection or via specular reflection, such as can be achieved by forming a metallic coating thereon. Further in some embodiments, a portion of the sidewall(s) may be adapted to reflect incident light via total internal reflection and another portion may be adapted to reflect the incident light via specular reflection.

The light pipe can be formed of a variety of different materials. For example, the light pipe can be formed of glass, acrylic polymers, polymethylmethacrylate (PMMA), polymethacrylmethylimid (PMMI), among others. In some embodiments, a portion of the light pipe can be formed of one material and another portion can be formed of a different material.

A variety of different light sources can be employed in the light module 10. By way of example, in this embodiment, the light source 110 can be a single LED (light emitting diode) chip having a flat light emitting surface. In other embodiments, the light source can include one or more domed light-emitting diodes, incandescent light bulbs, or other coherent or non-coherent light sources. Further, the light source 110 can include multiple light emitters, where each light emitter is adapted to generate light at a different frequency. By way of example, FIG. 1B shows a multi-LED chip 111 having a plurality of LEDs 111a, 111b, and 111c, each of which emits light at a different frequency (e.g., red, blue and green).

Referring again to FIG. 1A, the light pipe 100 can mix the light that it receives via its proximal end from the light source(s) 110. For example, the reflection(s) of the light rays at the sidewall(s) of the light pipe can cause mixing of those light rays. By way of example, such mixing of light rays can homogenize the light distribution received from a light source and/or cause a color mixing of light received from two or more light sources at different frequencies (colors).

The light pipe 100 can have any number of sidewalls and can have a variety of different cross-sectional shapes, including rotationally symmetric and asymmetric shapes. In this embodiment, the light pipe has a square cross-section with sidewalls 106a, 106b, 106c, and 106d, as shown schematically in FIG. 1B. In other embodiments, the cross-section of the light pipe 100 can be hexagonal, octagonal, star-shaped, elliptical, circular, etc. Further, while in some embodiments the light pipe can have a uniform cross-sectional area along its length, in other embodiments, the cross-section area of the light pipe can be non-uniform along its length. By way of example, the cross-sectional area of the light pipe 100 at its proximal end can be smaller than the cross-sectional area of the light pipe 100 at its distal end. In some embodiments, the cross-sectional area of the light pipe increases continuously from its proximal end to its distal end, e.g., at a draft angle in a range of about 1 degree to about 10 degrees.

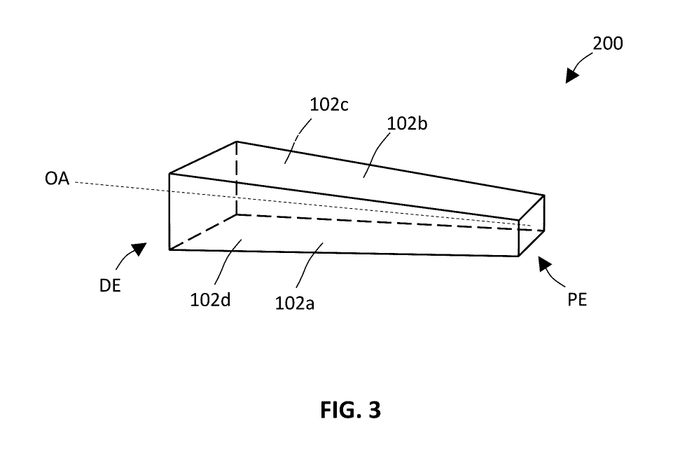

For example, FIG. 3 schematically depicts a light pipe 200 having four sidewalls 202a, 202b, 202c, and 202d (collectively referred to as sidewalls 202) imparting a square cross-section to the light pipe. The cross-sectional area of the light pipe in a plane perpendicular to its longitudinal axis OA increases from its light input surface to its light output surface. By way of example, the divergence angle of the sidewalls can be in a range of about 1 degree to about 10 degrees. The divergence of one sidewall relative to an opposed sidewall can be varied so as to alter the output light distribution. By way of example, a light beam exiting a light pipe 200 having sidewalls 202 that diverge along the length of the light pipe from the proximal end to the distal end can have a smaller divergence angle (e.g., as characterized by full width at half maximum (FWHM) of the light intensity distribution in a plane perpendicular to the direction of propagation) than a light beam exiting a similar square-shaped light pipe in which the sidewalls converge from the proximal end toward the distal end.

Referring again to FIG. 1A, the optical system 10 further includes a achromatic lens doublet 112, which is optically coupled to the light output surface of the light pipe 100 to receive at least a portion of the light exiting the light pipe. In this embodiment, the lens double 112 includes two lenses 112a, 112b, which comprise different polymeric materials. In this embodiment, the lens 112a provides a negative optical power while the lens 112b provides a positive optical power such that the lenses 112a and 112b collectively provide a positive optical power. By way of example, the lens 112a can provide a negative optical power in a range of about 5 to about 15 diopters and the lens 112b can provide a positive optical power in a range of about 15 to about 25 diopters. The optical power of the lens doublet 112 can be, for example, in a range of about 10 to about 20 diopters. Other optical powers for the negative and positive lenses can be selected based, for example, on the requirement of a particular application.

The index of refraction of each lens varies as a function of wavelength. In other words, in many embodiments, each lens exhibits dispersion in that it fails to focus all colors at the same convergence point. Thus, each lens individually exhibits a chromatic aberration, which results in variation of the focal length of that lens as a function of incident light wavelength. The two lenses are, however, selected so as to substantially compensate for each other's dispersion for at least two wavelengths, and preferably over a wavelength range, such that the lens doublet exhibits a chromatic aberration less than a desired threshold, e.g., equal to or less than about 0.3 diopters (e.g., in a range of zero to about 0.3 diopters), for those wavelengths and/or over the wavelength range. By way of example, in some embodiments, the focal shift over the wavelength range (e.g., a wavelength range of about 450 nm to 650 nm) is about 1 mm.

By way of example, consider a lens doublet having a desired focal length f_{d} at a given incident wavelength λ₁ (e.g., a wavelength of 589 nm) and exhibiting substantially identical focal lengths at wavelengths λ₂ and λ₃ (e.g., at wavelengths of 496 nm and 486 nm). In other words, the lens doublet would exhibit substantially vanishing chromatic aberration relative to the two wavelengths λ₂ and λ₃. For example, the focal lengths of the lenses 112a (f_{ad})) and 112b (f_{bd}) of such an achromatic lens doublet can be obtained, using a thin lens approximation, via the following relations:

$$\begin{matrix}\frac{1}{{f}_{ad}} = \frac{{V}_{ad}}{{f}_{d} ( {V}_{ad} - {V}_{bd} )} , & Eq . ( 1 ) \\ \frac{1}{{f}_{bd}} = \frac{{V}_{bd}}{{f}_{d} ( {V}_{bd} - {V}_{ad} )} . & Eq . ( 2 )\end{matrix}$$

where V_{ad} and V_{bd} are the Abbe numbers associated with the materials forming the lenses 112a and 112b. In particular, V_{ad} is defined according to the following relation:

$${V}_{ad} = \frac{{n}_{a {λ}_{1}} - 1}{{n}_{a {λ}_{2}} - {n}_{a {λ}_{3}}} , \qquad Eq . ( 3 )$$

where n_{aλ}_{₁}, n_{aλ}_{₂} and n_{aλ}_{₃} denote the indices of refraction of the material forming the lens 112a at the wavelengths λ₁, λ₂ and, λ₃ respectively. And V_{bd} is defined similarly as follows:

$${V}_{bd} = \frac{{n}_{b {λ}_{1}} - 1}{{n}_{b {λ}_{2}} - {n}_{b {λ}_{3}}} , \qquad Eq . ( 4 )$$

where n_{aλ}_{₁}, n_{aλ}_{₂} and n_{aλ}_{₃} denote the indices of refraction of the material forming the lens 112b at the wavelengths λ₁, λ₂ and, λ₃, respectively. It should be understood that the use of thin lens approximation in the above discussion is for illustrative purposes, and other methods, including numerical methods, can be employed to determine the focal lengths of the surface contours of the lenses 112a and 112b.

In some embodiments, the lens doublet is configured to exhibit a low chromatic aberration over a wavelength band, for example, over a range of about 400 nm to 700 nm.

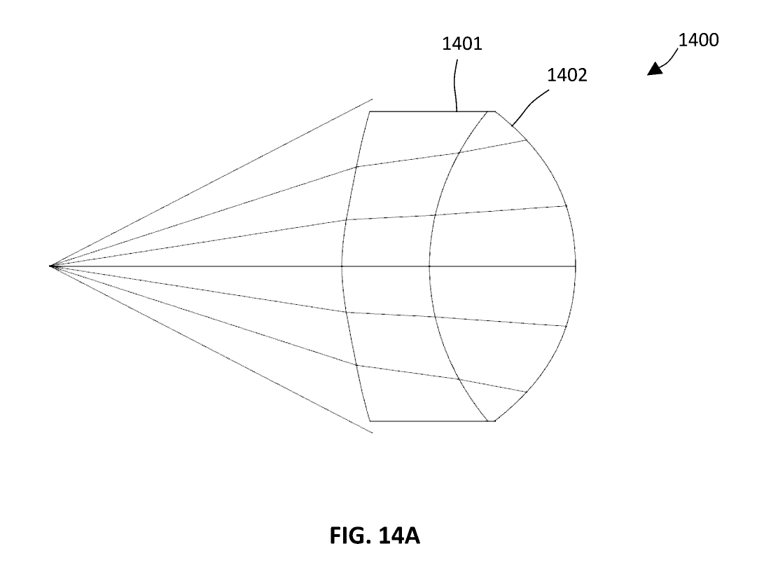

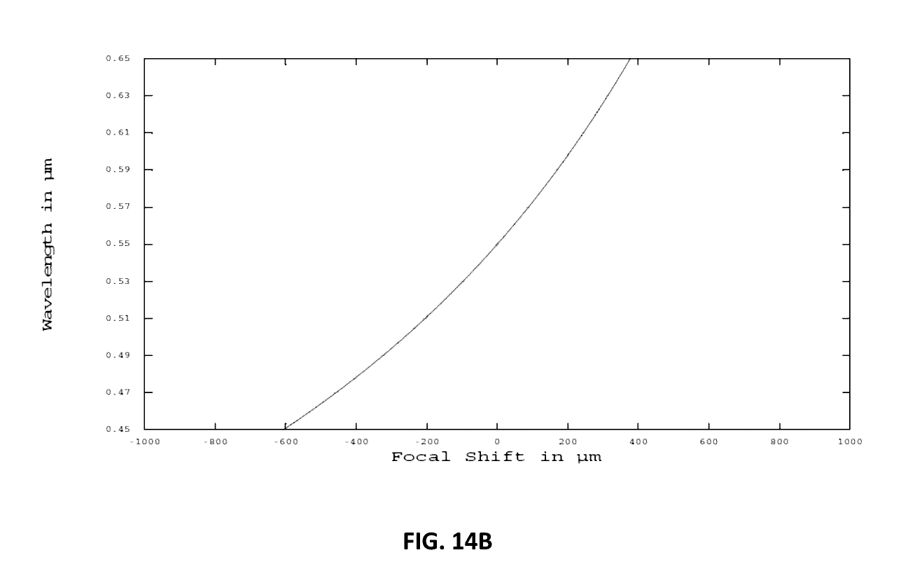

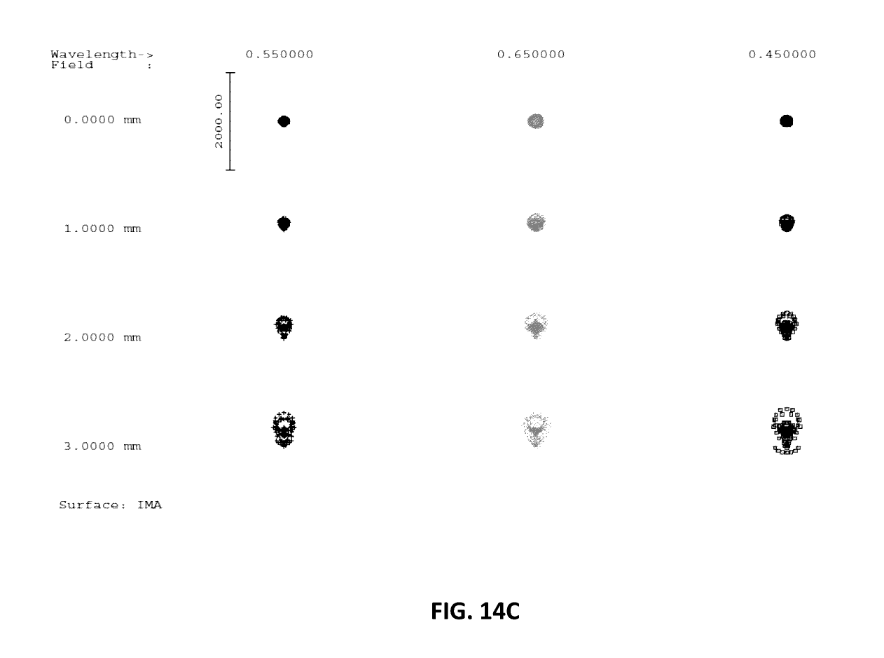

By way of example, the two lenses can be formed of two different polymeric materials, such as two different plastic materials, so as to reduce, and preferably eliminate, a chromatic aberration exhibited by the lens doublet, e.g., at two incident wavelengths. In some embodiments, the two polymeric materials are selected such that their Abbe numbers at a wavelength at which the nominal focal length of the lens doublet is desired (e.g., the above wavelength of 589 nm) and at two wavelengths at which chromatic aberration correction is desired (e.g., the above mentioned wavelengths 496 nm and 486 nm) can lead to the doublet exhibiting a focal length shift of less than about 1 mm over a desired wavelength range (e.g., a range of about 450 nm to about 650 nm). The variation in refractive index can be determined based on the desired focal shift of the two elements in the doublet. These values can be chosen by setting the sum of the paraxial transverse chromatic aberration contributions to zero and solving for the focal lengths of the individual elements. By way of example, FIG. 14B provides a plot of the focal shift plot of a doublet lens according to an embodiment over a wavelength range of 450 nm to 650 nm.

The lenses 112a and 112b can be formed of a variety of different materials. Some examples of suitable polymeric materials include, without limitation, polymethylmethacrylate, polycarbonate, polymethacrylmethylimid (PMMI), and silicone. For example, in this embodiment, the lens 112a can be formed of polycarbonate (PC) and the lens 112b can be formed of polymethylmethacrylate (PMMA).

It has been unexpectedly discovered that an achromatic lens doublet (such as the lens doublet 112) formed of different polymeric materials can exhibit a lower chromatic aberration and hence better performance in many lighting applications relative to polymeric achromatic lens doublets formed of the same polymeric material.

In some embodiments, the lens doublet 112 is movable relative to the light output surface 104 of the light pipe so as to adjust the size of the light beam projected via the lens doublet 112 onto a target surface, thereby providing a variable beam system. By way of example, at a distance between the light pipe's output surface 104 and the lens doublet 112 equal to the back focal length of the doublet, the beam projected by the lens doublet 112 will be substantially collimated and will have its minimum divergence. By moving the lens doublet 112 from this position toward the output surface of the light pipe, i.e., in the intra-focal range, the beam divergence can be increased with the maximum divergence corresponding to the position of the lens doublet at which the lens doublet touches the output surface. By way of example, in some embodiments, the maximum divergence of the beam can be about 70 degrees (wide beam) and the minimum divergence of the beam can be about 2 degrees (narrow beam). By moving the lens doublet 112 relative to the output surface 104 of the light pipe the beam's divergence can be varied between these two divergence values. A variety of mechanisms known in the art can be employed to mover the lens doublet relative to the output surface of the light pipe. By way of example, U.S. Pat. No. 4,885,600 entitled “Zoom mechanism for a zoom lens in cameras and the like” discloses such a zoom mechanism.

In some embodiment, the lens doublet can have an F-ratio in a range of about f/0.8 to about f/1.2 (e.g., f/1.047), though other F ratios can also be employed.

As noted above, the use of the lens doublet 112 can result in a significant reduction in, and in some cases, the elimination of, the chromatic aberration for at least two incident wavelengths and preferably over a wavelength range, which can in turn result in an enhancement of the system's performance. For example, in those embodiments in which the light pipe is coupled to two or more light sources generating light of different colors, the mixed light exiting the light pipe includes a mixture of light rays of different colors. The lens doublet 112 ensures that these different wavelength components of the light rays exiting the light pipe will be substantially focused on the same focal plane. If a projection lens that exhibits chromatic aberration were to be used, the different wavelength components of the light exiting the light pipe would be focused on significantly different focal planes, thus degrading the performance of the system. For example, a lens doublet according to the present teachings can exhibit a focal length shift of less than about 800 microns for incident wavelengths in a range of about 450 nm to about 650 nm. For example, in some embodiments, a change in the optical power of a lens doublet according to the present teachings due to chromatic aberration over a wavelength range of about 450 nm to about 650 nm can be less than 0.3 diopters, or less than 0.18 diopters.

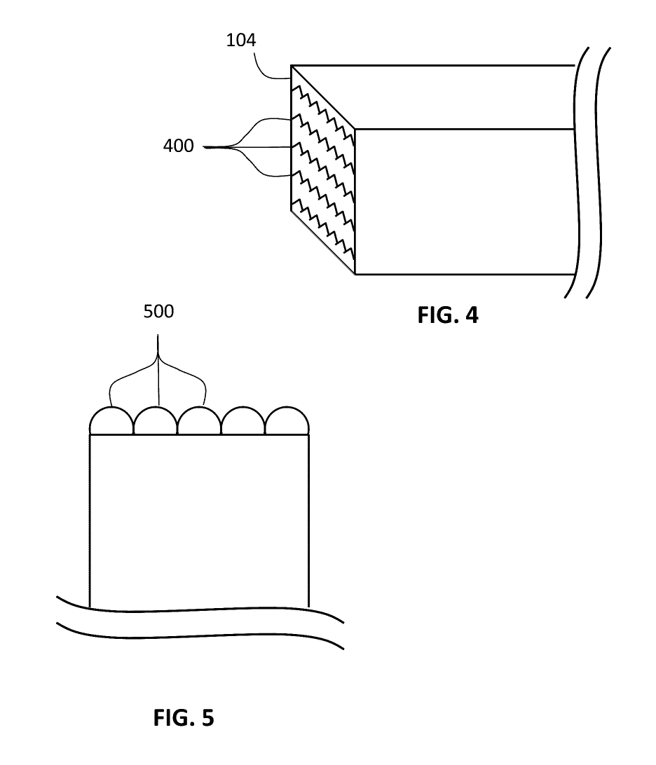

In some embodiments, the output surface of the light pipe has surface features (e.g., texturing), which can alter the characteristics of the output beam exiting the light pipe, e.g., by diverging, focusing, and/or diffracting the light incident thereon. By way of example, with reference to FIG. 4, the output surface 104 of the light pipe can include surface texturing in the form of a plurality of randomly distributed surface undulations 400 (e.g., in the form of spikes). In some implementations, the surface undulations can have a peak-to-trough height in a range of about 0.01 mm to about 0.25 mm.

It has been discovered that such surface texturing can synergistically cooperate with the lens doublet to enhance the performance of the optical system. By way of example, such texturing can improve color uniformity of the output beam. Color uniformity is typically defined as the root-mean-square (RMS) distance between a measured set of chromaticity coordinates and the average of all chromaticity measurements in the beam. The texturing can improve the color uniformity, e.g., by way of surface scattering. Without being limited to any particular theory, the surface texturing can result in the generation of a plurality of point-like illumination centers across the output surface of the light pipe, where the light emanating from each of these light-emitting centers can be effectively focused onto a target surface by the lens doublet. The texturing can also enhance the mixing of the light rays as they exit the light pipe. In other words, in many embodiments, the surface texturing provides a luminous surface that functions effectively as a Lambertian source of light for the lens doublet, which improves the focusing of the light exiting the light pipe by the lens doublet.

The surface texturing 400 can be formed on the output surface of the light pipe using a variety of difference techniques. By way of example, chemical and/or mechanical etching can be employed to generate the surface texturing.

In some embodiments, the surface features of the output surface of the light pipe can be in the form of a plurality of microlenses. By way of example, FIG. 5 schematically depicts an exemplary implementation of such an embodiment in which a plurality of microlenses 500 are formed on the output surface 104 of the light pipe. While in this embodiment the microlenses are formed integrally on the output surface, in other embodiments the microlenses can be formed as a separate unit and optically coupled to the light pipe's output surface. In some embodiments, each of the microlenses can be dimensioned such that it is at least about 10 times smaller (e.g., its height is at least 10 times smaller) than the maximum linear dimension of the output surface 104. In some embodiments, the microlenses can have a radius in a range of about 0.25 mm to about 5 mm. The microlenses can also be effective in enhancing the mixing of light rays exiting the light pipe and/or shaping the output beam of the light pipe. In some embodiment, the microlenses can increase the width of the beam exiting the light pipe (e.g., the microlenses can provide a beam with a divergence angle of 60 degrees), thereby increasing the system's etendue. In such embodiments, the microlenses can provide a controlled mechanism for increasing the etendue.

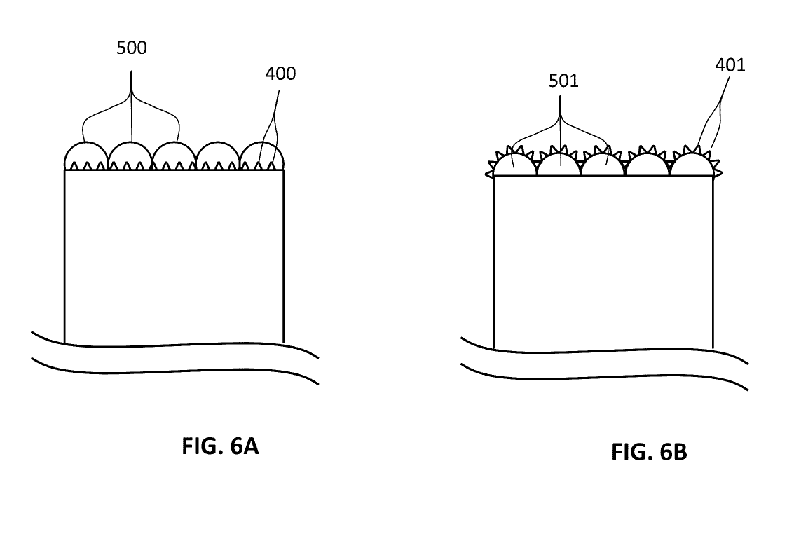

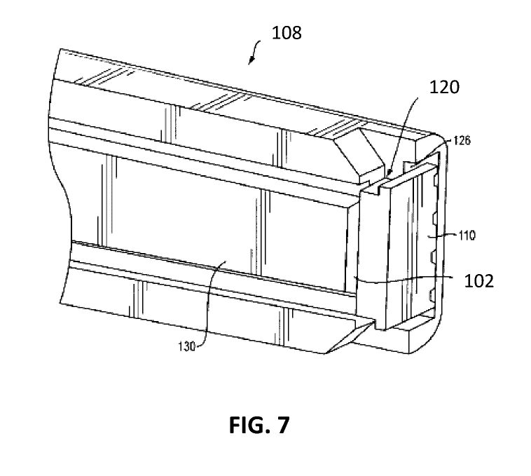

With reference to FIG. 6A, in some embodiments, the output surface can include a combination of surface texturing 400 and a plurality of microlenses 500. For example, the output surface of the light pipe can be etched (e.g., via chemical or mechanical etching) to impart a plurality of surface undulations (e.g., in the form of spikes) thereto. By way of example, the surface texturing can be in the form of a plurality of surface undulations (e.g., regularly or randomly distributed across the surface) having peak-to-trough heights in a range of about 0.01 mm to about 0.25 mm and the microlenses can be those discussed above. It has been discovered that the combination of the surface texturing and the microlenses can improve the performance of the optical system.

With reference to FIG. 6B, in some embodiments, the output surface of the light pipe can include a plurality of microlenses 510 having surface texturing 401. Similar to the previous embodiments, such surface texturing can be characterized by peak-to-trough heights in a range of about 0.01 mm to about 0.25 mm.

As noted above, in some embodiments, the microlenses can increase the angular spread of the light exiting the light pipe so as to maximize the surface area of the projection lens that is illuminated by the light from the light pipe. The ability to spread the light exiting the light pipe in this manner can improve the beam appearance and the etendue of the system throughout the zoom range. In some cases, the microlenses can perform this function more efficiently than surface texturing alone. In embodiments in which both microlenses and surface texturing are employed, the combination of the microlenses and surface texturing can provide certain advantages. For example, the texturing can mitigate certain artifacts caused by the microlenses. For example, each “valley” portion of a microlens can act as an individual negative lens. As such, the light emanating from these regions can be dispersed, leading to dark spots in the beam. The surface texturing can scatter some of the light into these dark regions, thereby improving the beam's illumination uniformity. Hence, the combination of the microlenses and surface texturing can enhance the beam's illumination and color uniformity.

With reference to FIGS. 1A and 7, the light pipe 100 can be seated in a holder 108. As shown schematically in FIG. 7, a light source 110 can be secured within a cavity provided at the proximal end of the holder 108 and the light pipe can be disposed within a bore 130 provided by the holder. The holder can include a shoulder 126 against which the light source 110 can abut. Moreover, the shoulder 126 can include one or more vents 120 that allow the dissipation of heat generated by the light source. Thus, the holder can be utilized to align the input surface 102 of the light pipe 100 with the light source 110 so as to efficiently couple the light generated by the light source 110 into the light pipe. A gap (e.g., an air gap) between the light source 110 and the input surface 102 of the light pipe can be in communication with vents 120 so as to prevent the overheating of the light source. Further details regarding a holder suitable for securing the light pipe and coupling the light pipe to one or more light sources can be found, e.g., in U.S. Published Application No. 2013/0215636, entitled “Light Mixing Lenses and Systems,” which is herein incorporated by reference in its entirety.

The above optical systems can find a variety of different applications, e.g., multi-LED variable spot systems. The optical systems according to the present teachings can improve color-over-angle performance in lighting systems employing chip-on-board (COB) LEDs.

The following examples are provided for illustrative purposes and are not intended to necessarily indicate the optimal ways of practicing various aspects of the invention or optimal results that can be obtained.

### EXAMPLES

By way of further illustration, examples of light systems employing a lens doublet for projecting mixed light exiting a light pipe onto a target surface are considered to illustrate some of the advantages of disclosed lighting systems.

In the theoretical examples below, the optical system includes (1) a light pipe (which is referred to as a “color mixing rod”) that is optically coupled to a multi-color LED (as for instance the OSRAM OSTAR RGBW LED) to receive light generated thereby; and (2) an all-plastic lens doublet that is optically coupled to an output surface of the color mixing rod. The mixing rod is used to mix light rays at different colors emitted by the LED and the lens doublet is used to project the light exiting the rod onto a target surface. As noted above, the lens doublet can be moved relative to the output surface of the rod to adjust the angular spread of the beam.

In one example, the system is assumed to have a lens doublet in which both lenses are formed of the same plastic material and in other examples, the system is assumed to have a lens doublet formed of different polymeric materials. It is found that the optical performance of the systems in which the lens doublet is formed of different polymeric materials is much enhanced relative to that of the system in which the lens doublet is formed of the same polymeric material. In particular, it is found that a light spot generated by the combination of a color mixing rod and an achromatic lens doublet formed of different polymeric materials is less susceptible to chromatic aberrations. For example, the chromatic aberration associated with a single lens, or a doublet formed of the same polymeric material, can result in a strong change in color temperature from the center of the spot to its edges. In other words, the use of a single lens or doublet formed of the same plastic material can result in a large COA variation, e.g., large variations in the chromatic coordinates X,Y from the center of the spot to its edges. In contrast, as discussed below, a system in which a lens doublet according to the present teachings is employed to project the light exiting the light pipe can exhibit a much enhanced Color-Over-Angle (COA) homogeneity.

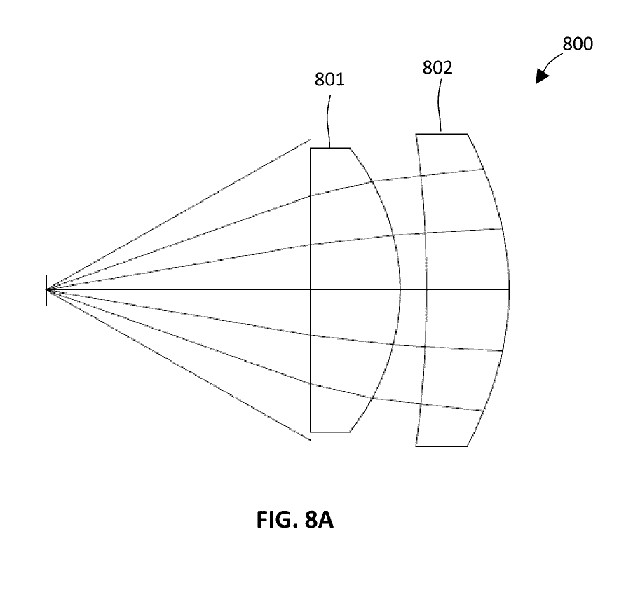

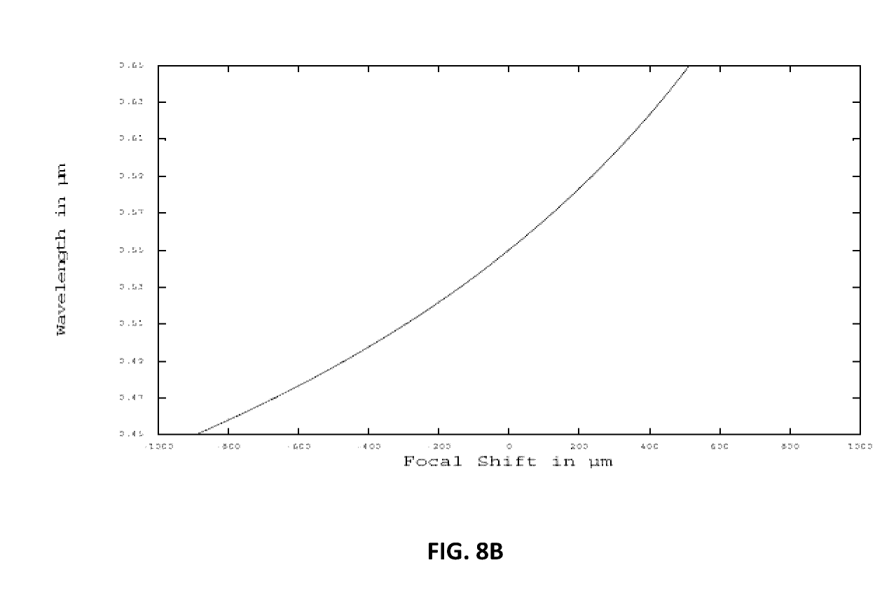

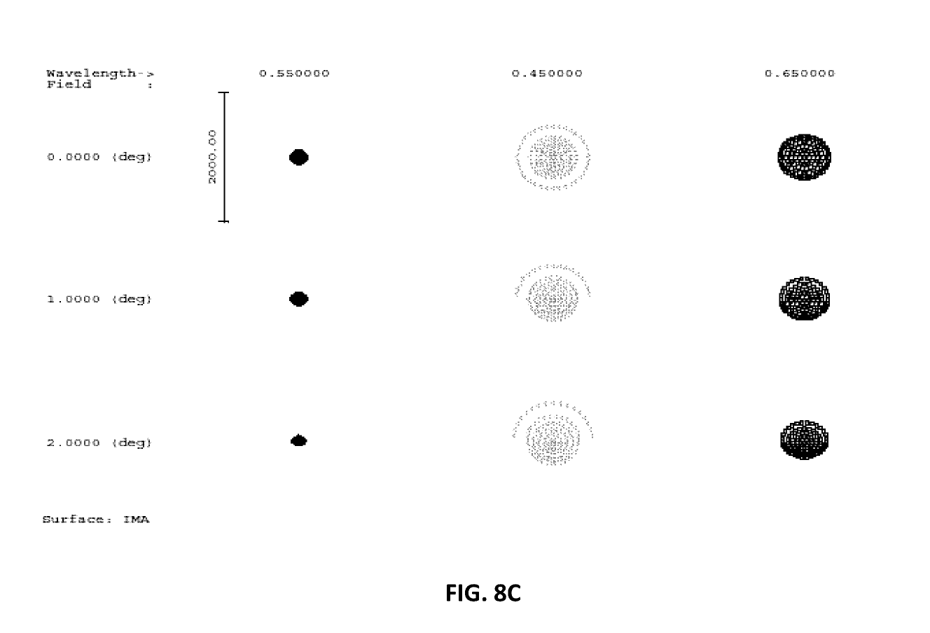

By way of example, FIG. 8A schematically shows a lens doublet 800 made of two PMMA lenses 801 and 802 that are separated by an air gap, where the doublet has a theoretically calculated focal length of 67 mm at incident radiation wavelength of 589.3 nm (refractive index specified to d-line) and a diameter of 64 mm. FIG. 8B shows the chromatic focal shift exhibited by this doublet as a function of wavelength of incident light. FIG. 8C shows a calculated RGB spot diagram for this lens doublet, depicting significant differences in the spot sizes for the red, green and blue light at nominal focal plane of the lens. The data presented in FIGS. 8B and 8C show that this lens doublet exhibits a significant chromatic aberration.

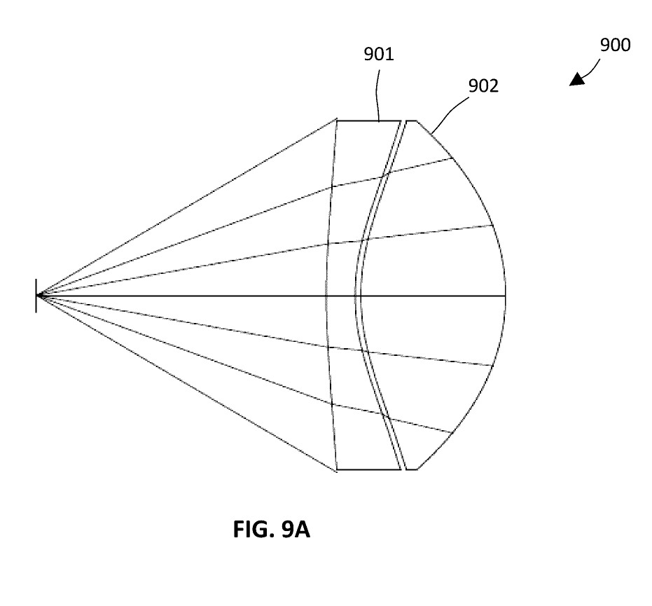

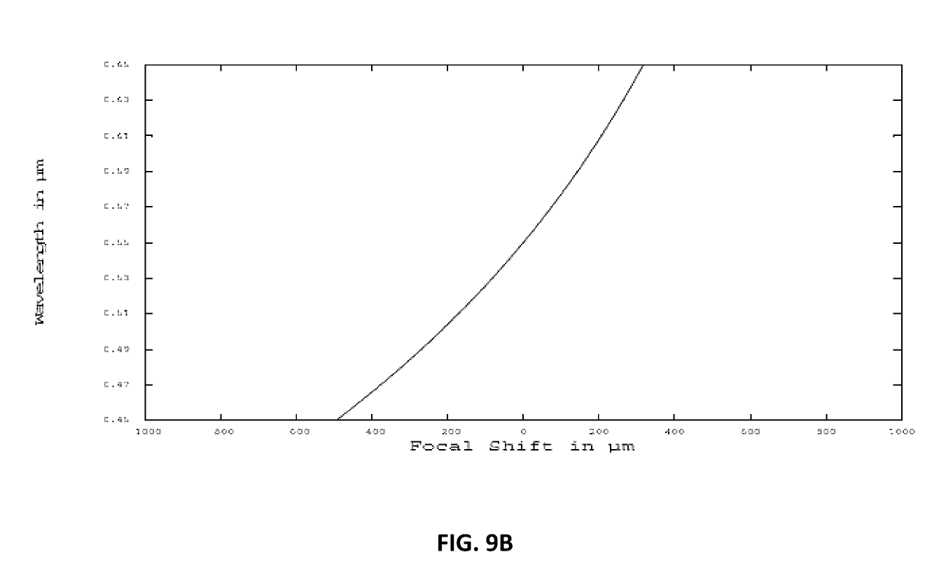

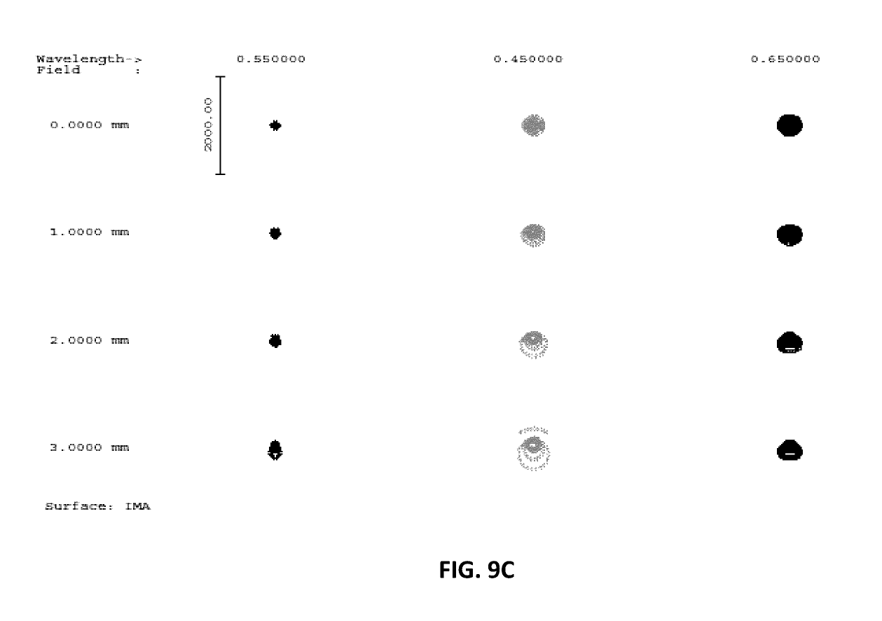

By way of comparison, FIG. 9A schematically shows a lens doublet 900 including lenses 901 and 902 having a diameter of 64 mm in which one lens 901 is formed of polycarbonate and the other lens 902 is formed of PMMA. The two lenses 901 and 902 are separated from one another by an air gap. The lenses 901 and 902 were selected such that the theoretical focal length of the doublet would be 67 mm at incident radiation wavelength of 589.3 nm. FIG. 9B shows the calculated chromatic focal shift exhibited by the doublet 900 as a function of the incident wavelength, and FIG. 9C shows a calculated RGB spot diagram for this doublet. A comparison of data presented for the CFD doublet 900 with that of the above doublet 800 shows that by replacing the PMMA lens 801 in doublet 800 with a lens formed of PC, the chromatic aberration exhibited by the doublet can be reduced. The lens doublets 800 and 900 are identical in all respects except that the lens 801 formed of a PMMA is replaced with the lens 901 formed of PC to form the lens doublet 900.

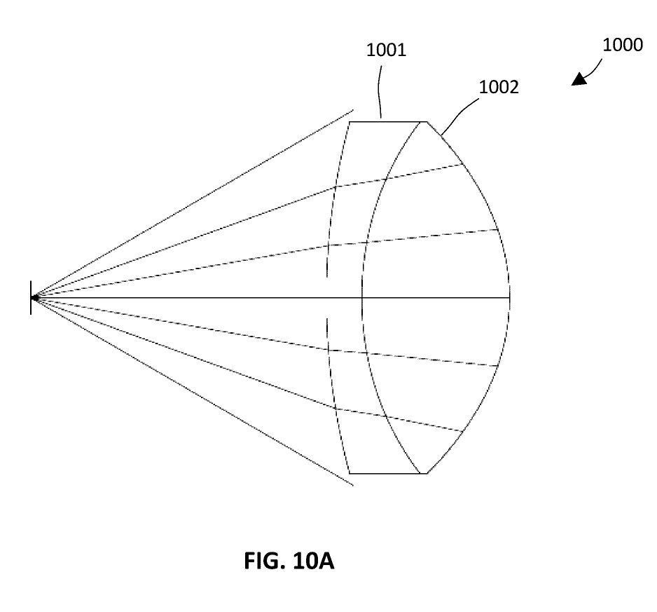

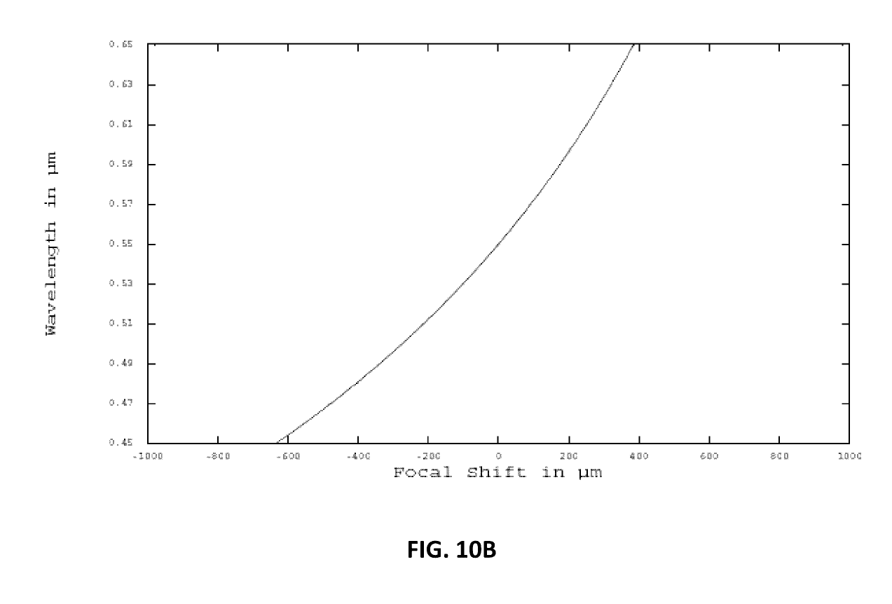

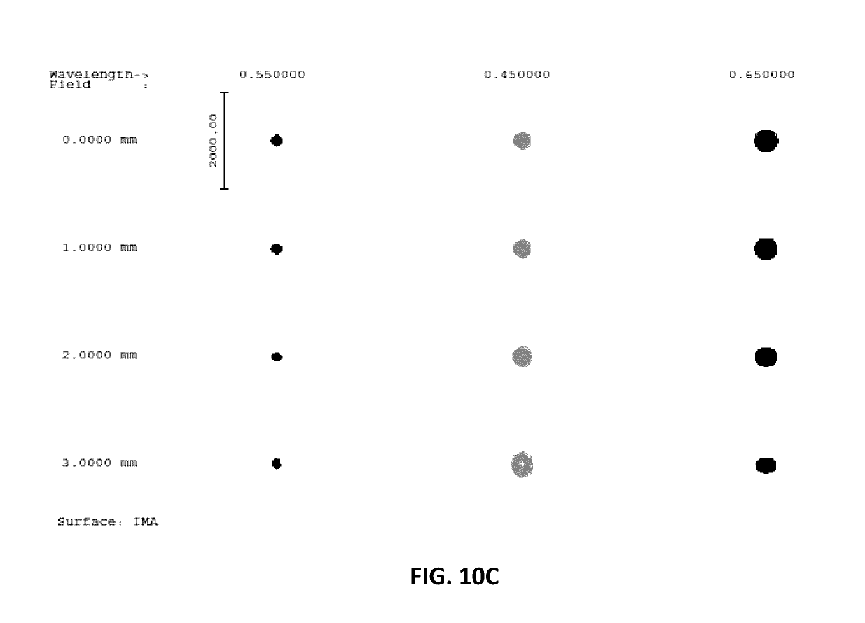

By way of further illustration, FIG. 10A schematically shows a lens doublet 1000 having a diameter of 64 mm and a nominal focal length of 67 mm at incident radiation wavelength of 589.3 nm. The lens doublet 1000 is formed of a PC lens 1001 and a PMMA lens 1002 that are cemented together (no air gap is present between the two lenses). FIG. 10B presents a calculated chromatic focal length shift exhibited by the lens doublet 1000 as a function of incident light wavelength. FIG. 10C shows a calculated RGB spot diagram for this lens. The data presented in FIGS. 10B and 10C show that the lens doublet 1000 exhibits a much lower chromatic aberration and hence an improved performance relative to the above lens doublet 800 in which both lenses are formed of PMMA (e.g., compare the spot diagram for this lens with that for the lens doublet 800).

The F-ratio of each of the above lens doublets is about F/1. Hence, these lens doublets are efficient at collecting the incident light. However, the lens doublets 900 and 1000 in which the two lenses are formed of different polymeric materials exhibit a much lower chromatic aberration relative to the lens doublet 800 in which both lenses are formed of the same polymeric material, namely PMMA.

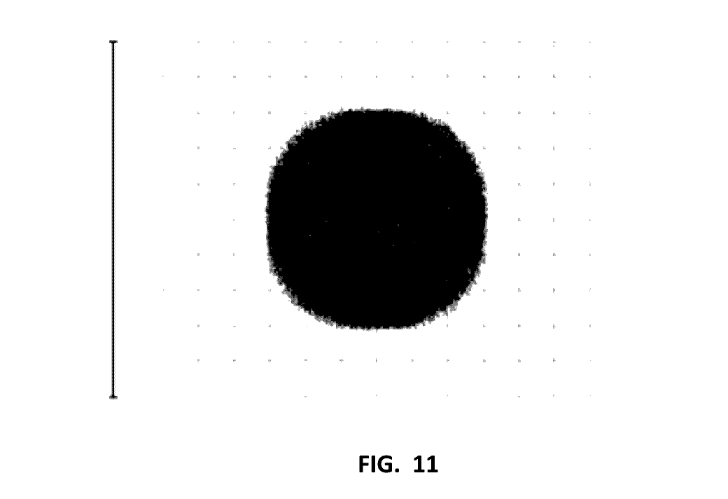

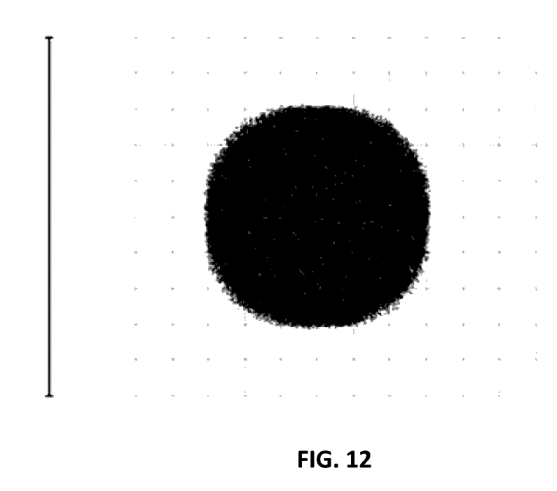

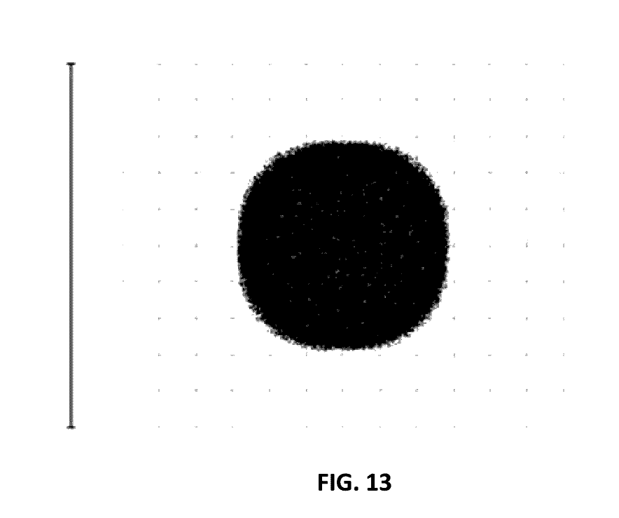

The two color free doublets 900 and 1000 can demonstrate good performance for lighting applications, such as color mixing variable spot systems. By way of example, FIG. 11 presents simulated data corresponding to the distribution of red, green, and blue light rays on the nominal focal plane of the doublet 800 when the doublet receives mixed red, green, and blue light from the output surface of a light pipe. FIG. 12 shows simulated data corresponding to the distribution of red, green and blue light rays on the nominal focal plane of the doublet 900 when that doublet receives mixed red, green, and blue light from the output surface of a light pipe. In both cases, the simulated data show a substantially uniform distribution of light rays of different colors across the spot light. Such a distribution of different colors can be characterized by a Color-Over-Angle (COA) as follows: CIEX, CIEY less than 0.02 from 0 to 60 degrees or Du′v′ of less than 0.003. Those skilled in the art appreciate the CIEX and CIEY refer to color coordinates in a color space created by Commission Internationale d'Eclairage (CIE) that defines quantitative links between physical colors (i.e., wavelengths) in the visible portion of the electromagnetic spectrum and physiological perceived colors in human color vision. Du′v′ expresses the distance in the chromaticity plane define by u′v′. In contrast, FIG. 13 shows similar data for red, green and blue colors distributed across a focal spot light generated by the above doublet 800 in which both lenses are formed of PMMA. This data shows a less uniform distribution of colors across the light spot with the red color more concentrated along the outer edge of the light spot.

As noted above, a variety of combinations of different polymeric materials can be employed to form a color-free-doublet according to the present teachings. By way of example, FIG. 14A schematically depicts a lens doublet 1400 in which lens 1401 is formed of polycarbonate (PC) and lens 1402 is formed of silicone, where the doublet has a diameter of 64 mm and a nominal focal length of 67 mm at incident radiation wavelength of 589.3 nm. FIG. 14B shows a calculated chromatic focal shift of such a lens as a function of incident light wavelength, and FIG. 14C shows a calculated RGB spot diagram for this lens. The data presented in FIGS. 14B and 14C show that the lens doublet 1400 formed of silicone and polycarbonate exhibits a reduced chromatic aberration and is suitable for lighting applications, such as variable spot mixed lighting applications.

By way of further illustration, Table 1 below provides a summary of data for a doublet lens according to an embodiment in which one lens is formed of polycarbonate and the other lens is formed of PMMA:

TABLE 1

| Surf | Type | Radius | Thickness | Glass | Diameter | Conic |
|---|---|---|---|---|---|---|
| OBJ | STANDARD | Infinity | Infinity | | 0 | 0 |
| STO | EVENASPH | 38.03167 | 25 | PMMA | 65 | −0.8115513 |
| 2 | EVENASPH | −40.91264 | 1 | | 65 | 0 |
| 3 | EVENASPH | −39.58513 | 5 | POLYCARB | 65 | 0 |
| 4 | STANDARD | −111.7487 | 50 | | 65 | −180.9316 |
| IMA | STANDARD | Infinity | | | 6.81151 | 0 |

Various parts, components or configurations described with respect to any one embodiment above may also be adapted to any others of the embodiments provided.

The present disclosure is not to be limited in terms of the particular embodiments described in this application, which are intended as illustrations of various aspects. It will be readily understood that the aspects of the present disclosure, as generally described herein, and illustrated in the figures, can be arranged, substituted, combined, separated, and designed in a wide variety of different configurations, all of which are explicitly contemplated herein. Many modifications and variations can be made without departing from its spirit and scope, as will be apparent to those skilled in the art.

What is claimed is:

1. A lighting system, comprising
a light pipe having an input surface for receiving light from at least one light source and an output surface through which light exits the light pipe, and
a lens doublet comprising two lenses and optically coupled to said output surface of the light pipe for receiving at least a portion of the light exiting the light pipe and projecting said light onto a target surface,
wherein said lens doublet exhibits a chromatic aberration less than a chromatic aberration exhibited by each of said two lenses.

2. The lighting system of claim 1, wherein said two lenses include different polymeric materials.

3. The lighting system of claim 1, wherein said lens doublet exhibits a chromatic aberration less than about 0.3 diopters for wavelengths in a range of about 450 nm to about 650 nm.

4. The lighting system of claim 1, wherein said lens doublet is configured so as to generate a light spot on its nominal focal plane exhibiting a Color-Over-Angle (COA) variation characterized by CIEX, CIEY less than 0.02 for angles in a range of 0 to about 60 degrees.

5. The lighting system of claim 1, wherein said lens doublet provides a positive optical power in a range of about 10 to about 20 diopters.

6. The lighting system of claim 1, wherein one of said lenses provides a positive optical power and the other provides a negative optical power.

7. The lighting system of claim 6, wherein said positive optical power is in a range of about 15 to about 25 diopters in air and said negative optical power is in a range of about 5 to about 15 diopters in air.

8. The lighting system of claim 1, wherein at least one of said two lenses includes a polymer selected from the group consisting of polymethylmethacrylate (PMMA), polycarbonate (PC), polymethacrylmethylimid (PMMI), and silicone.

9. The lighting system of claim 1, wherein one of said lenses is formed of PMMA and the other is formed of PC.

10. The lighting system of claim 9, wherein one of said lenses is formed of silicone and the other is formed of PC.

11. The lighting system of claim 1, wherein said light source is a multi-color LED.

12. The lighting system of claim 1, wherein said lens doublet is movable relative to the output surface of the light pipe along a longitudinal axis of the light pipe.

13. The lighting system of claim 1, wherein said lens doublet has an F-number in a range of about f/0.8 to about f/1.2.

14. The lighting system of claim 1, wherein said output surface of the light pipe comprises surface texturing characterized by a plurality of surface undulations having peak-to-trough heights in a range of about 0.01 mm to about 0.25 mm.

15. The lighting system of claim 1, wherein said output surface of the light pipe comprises a plurality of microlenses.

16. The lighting system of claim 15, wherein said output surface comprises surface texturing characterized by a plurality of surface undulations having peak-to-trough heights in a range of about 0.01 mm to about 0.25 mm and a plurality of microlenses.

17. The lighting system of claim 15, wherein said microlenses comprise surface texturing disposed on surfaces thereof through which light exits the microlenses.

18. The lighting system of claim 17, wherein said surface texturing is characterized by a plurality of surface undulations having peak-to-trough heights in a range of about 0.01 mm to about 0.25 mm.

19. The lighting system of claim 1, wherein said light pipe has a length that is at least 10 times greater than a maximum linear dimension of each of said input and output surface.

20. The lighting system of claim 1, wherein said light pipe has a polygonal cross section.

21. A lighting system, comprising a light pipe having an input surface for receiving light from at least one light source and an output surface through which light exits the light pipe, and
a lens doublet optically coupled to said output surface of the light pipe for receiving at least a portion of the light exiting the light pipe and projecting said light onto a target surface,
wherein said lens doublet comprises a first lens formed of one polymeric material and a second lens formed of a different polymeric material, said lenses being configured such that said lens doublet exhibits a chromatic aberration less than about 0.3 over a wavelength range of about 450 nm to about 650 nm.

22. The lighting system of claim 21, wherein said light source comprises a multi-color LED.
